(19) United States
(12) Patent Application Publication
(10) Pub. No.: US 2005/0081799 A1
(43) Pub. Date: Apr. 21, 2005

(54) Collar

(76) Inventor: Eddie Huntley III, Atlanta, GA (US)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 10/926,919

(22) Filed: Aug. 26, 2004

Related U.S. Application Data
(60) Provisional application No. 60/511,450, filed on Oct. 15, 2003.

(51) Int. Cl. A01K 27/00

(52) U.S. Cl. 119/858

(57) ABSTRACT

An animal collar is disclosed to limit irritation and loss of hair around an animal's neck. The part of the collar in contact with the animal remains relatively stationary.

### RELATED US APPLICATION DATA

This application claims the benefit of U.S. Provisional Application No. 60/511,450 filed 15 Oct. 2003.

### BACKGROUND OF THE INVENTION

1. Field of the Invention

The present invention generally relates to collars, specifically to animal collars that limit irritation and loss of hair around the necks of animals.

2. Description of Related Art

Collars are worn by many animals, including dogs and cats, and sometimes by children. Many animals will wear a collar for most of their lives. Unfortunately, collars irritate the neck. Whenever the collar moves, it creates friction with the neck, causing irritation, itchiness, and even a loss of hair, fur, or wool in the area around and on the neck. The collar moves when the leash that is attached to the collar is pulled or dragged. The collar can be pulled or dragged when the animal is walked or tied up. For example, when the animal changes direction or attempts to go beyond the range of its leash, the collar will rub against the neck.

Also, a collar's movement around the neck of an animal increases the likelihood that the hair, fur, or wool of the animal will tangle with the collar, causing the animal unnecessary pain and discomfort. Animals have a difficult time untangling their hair. As a result, they often scratch their necks or chew the hair, fur, or wool around their necks in order to alleviate their discomfort.

The present invention is primarily directed at overcoming these issues with the conventional collar.

### SUMMARY OF INVENTION

Briefly described in preferred form, the present invention is a collar that reduces the irritation associated with wearing the collar around the neck. This is accomplished by having a connector member, movable about at least a portion of the neck without contacting the neck. An encircling member of the collar remains relatively idle on the neck. In a preferred embodiment, an inner part of the collar is made of a soft, comfortable material and will rest relatively idly on the neck even while the animal is leashed and the leash is pulled and dragged.

Therefore it is an object of the present invention to provide a collar that greatly reduces the amount of irritation encountered at the neck of an animal due to the movement of its collar.

It is a further object of the present invention to reduce the tangling of the hair, fur, or wool around the neck of an animal.

These and other objects, features and advantages of the present invention will become more apparent upon reading the following specification in conjunction with the accompanying drawing figures.

### BRIEF DESCRIPTION OF THE DRAWINGS

FIG. 1 illustrates a perspective view of the present invention according to a preferred embodiment.

FIG. 2 illustrates an exploded view of the invention of FIG. 1.

FIGS. 3A-3D illustrate one embodiment of the connector member of the present invention.

FIG. 4 shows one embodiment of the encircling member of the present invention.

FIG. 5 illustrates another embodiment of the connector member of the present invention.

FIG. 6 is a perspective view of a jewelry unit of the present.

FIGS. 7-9 illustrate perspective views of the present invention according to other preferred embodiments.

FIG. 10 shows another embodiment of the encircling member of the present invention.

### DETAILED DESCRIPTION OF PREFERRED EMBODIMENTS

Referring now in detail to the drawing figures, wherein like reference numerals represent like parts throughout the several views, FIG. 1 illustrates a preferred embodiment of the present a collar 10. The collar 10 comprises an encircling member 20 that encircles the neck of the animal, and a connector member 30 that can rotate about the neck in communication with the encircling member 20. The connector member 30 can move around the encircling member 20 without contact with the neck, thus making the present invention 10 a much more comfortable collar. A leash (not shown) can then be attached to the connector member 30. When used, the present invention 10 enables the leash to move about the animal's neck without twisting the collar, and making for an uncomfortable fit with the animal.

FIG. 1 illustrates the present invention 10, wherein the encircling member 20 comprises a body 22, a platform 24 extending outward from the body 22, and having two tracks 26 at the junction of the body 22 and platform 24. The platform 24 can be of unitary construction with the body 22, or, alternatively releasably attached to the body 22 by VELCRO or the like so the collar is easily alterable by the user. That is, the body 22 and platform 24 can be sold separately, and the user mix and match various sizes, shapers, materials, colors, and the like bodies 22 and platforms 24 at their whim.

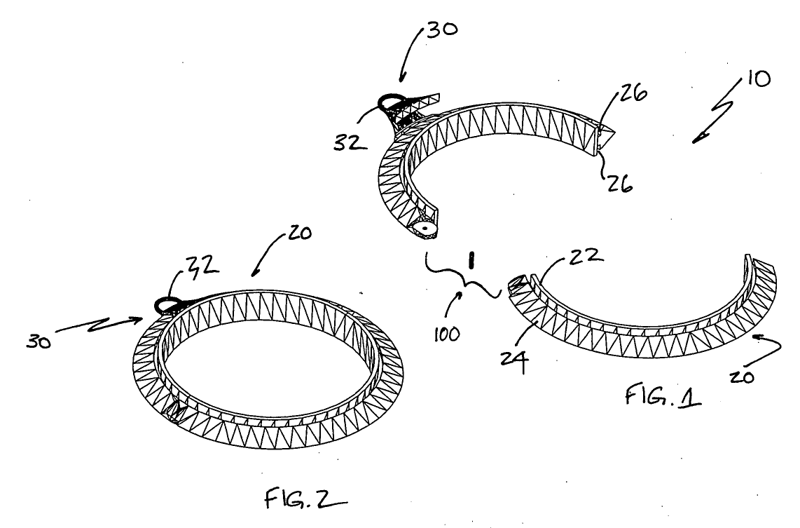

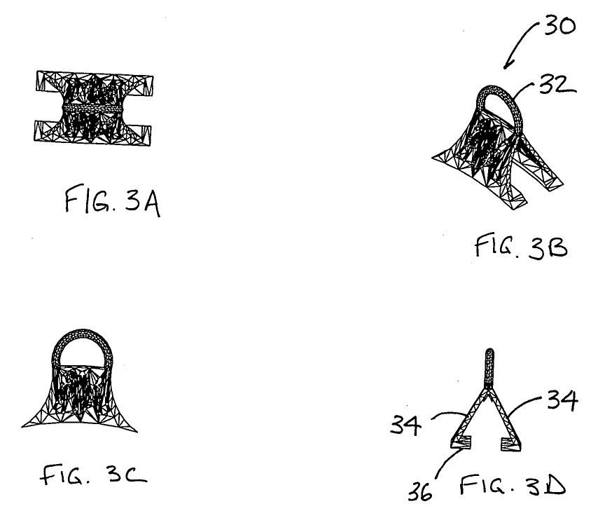

The connector member 30 comprises a loop 32 for connecting to a leash, and two flanges 34 that have portions that ride within the corresponding tracks 26. The encircling member 20 is open in FIG. 1, and closed in FIG. 2. The connector member 30 of this embodiment is illustrated in FIGS. 3A-3D. Flanges 34 of connector member 30 can further comprising track riding portions 36.

As shown in FIGS. 1-3D, the platform 24 can be triangular in shape extending normal from the body 22. The tracks 26 are spaced apart in similar design as the flanges 34, and the depth of the tracks can be similar to the length of the portions 36. The connector member 30 too can be triangular in shape.

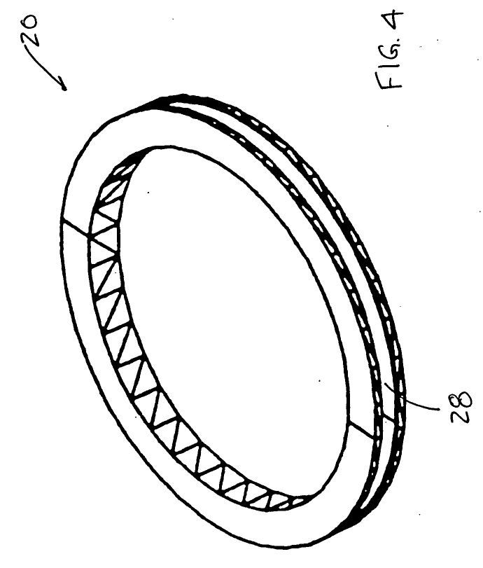

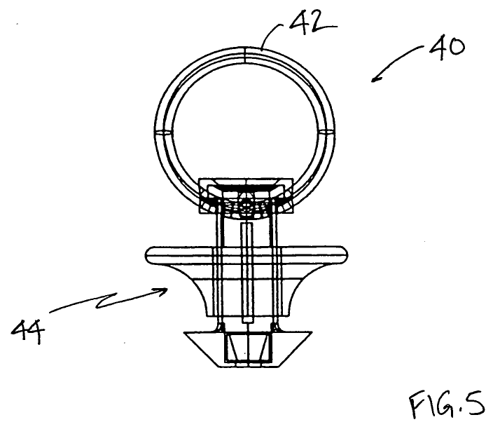

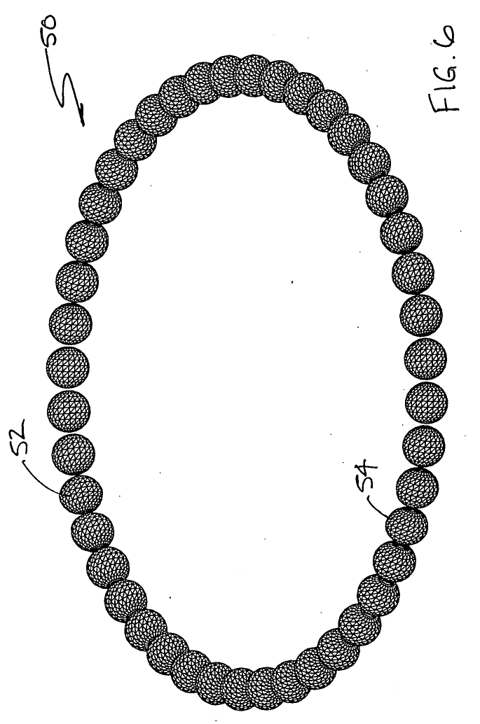

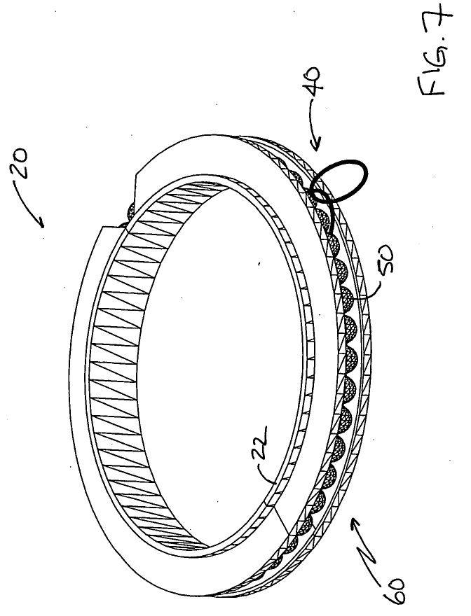

While the encircling member 20 can comprise as outwardly flared platform 24 to facilitate ultimate connection to a leash, the encircling member 20 can comprise an inwardly formed channel 28 as shown in FIG. 4. In such an embodiment, the connector member is designed to ride within the channel 28, wherein FIG. 5 illustrates one such connector member 40. Connector member 40 comprises a loop 42 for connecting to a leash, and a body 44 designed to cooperate with the channel 28, such that connector member 40 can move smooth around the encircling member 20, but not separate away from the member 20.

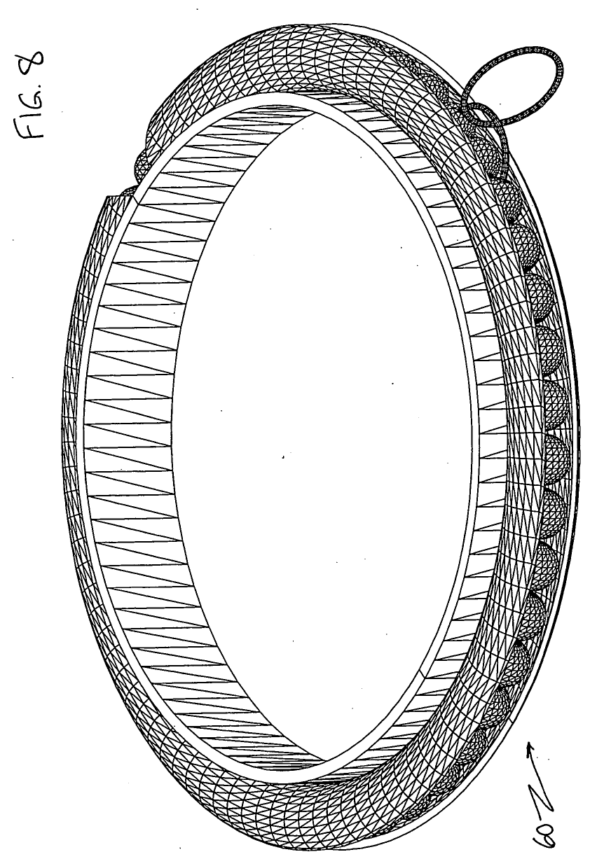

Jewelry 50 can be incorporated with the invention 10. As shown in FIGS. 6-7, a jewelry piece 50 can be accommodated in channel 28, wherein a connector member 40 is located as well. Jewelry 50 can incorporate a plurality of pieces 52. For example, the jewelry 50 can comprise steel ball bearings 54 either separately movable, or linked together, that are moveable within a track or channel. The jewelry 50 can further include, among others, studs, spikes, precious stones, birthstones, gems, beads, feathers, metal decorations, and wood decorations.

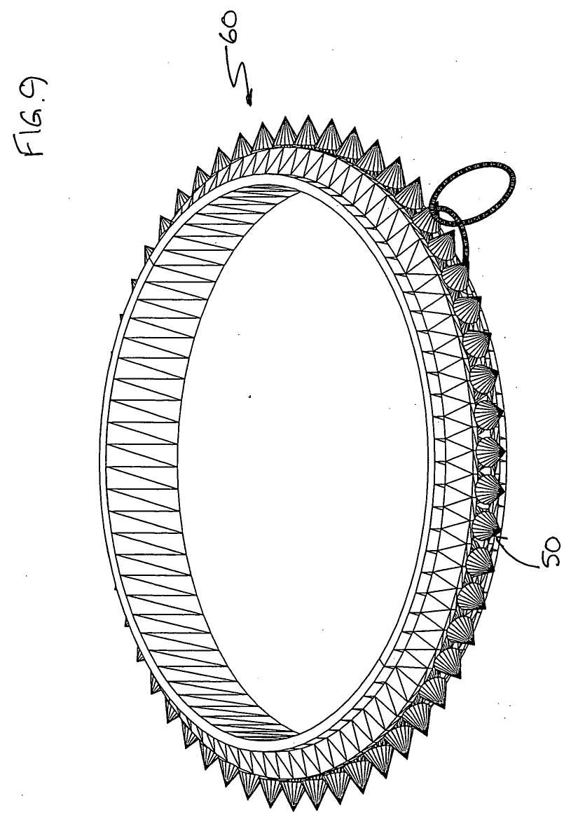

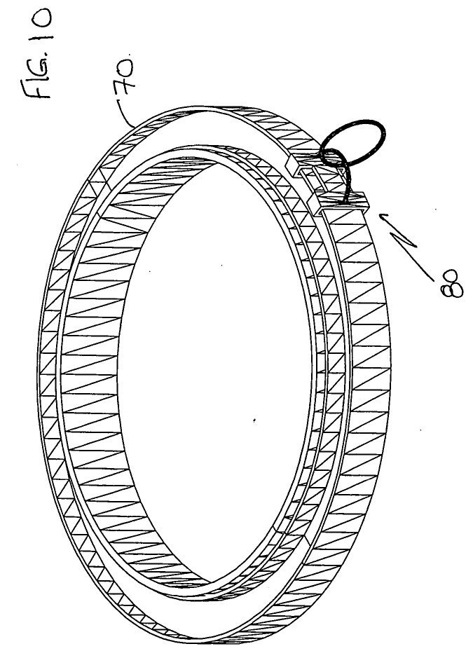

Additional embodiments include an encircling member 20 comprising an outwardly flared channel system 60, extending from the body 22, wherein the connector member 40 and perhaps jewelry 50, and contained within the channel system 60, as shown in FIGS. 8-9. The encircling member 20 can also comprise an outer ring 70 around which a connector member in the form of a shuttle 80 can move, as shown in FIG. 10.

The encircling member 20 itself preferably has minimal movement around the neck, for the animal's comfort, where the leash is movable about the animal via the connector member 30. The encircling member 20 can incorporate an inner surface of soft padding material, such as cotton, silk, polyester, sponge, flannel, foam, feathers so the collar feels comfortable on the neck. The inner surface 20 of the member can further include a gel layer and a magnetic layer, for either or both massaging with the gel, and magnetic therapy.

The encircling member 20 can in whole or in part include cowhide, leathers, cotton, nylon, polyester, suede, silks, acrylic, linen, rayon, velour, velvet, raincoat material, and elastics, or skins and mixture of skins, such as snake, ostrich, alligator, crocodile, elephant, leopard, zebra, bear, shark, rabbit, minx, fox, pig, chinchilla, lion, or metals and rubbers. In another embodiment, the encircling member 20 can incorporate air pockets 90 therein that can be inflated for adjustable for comfort and fit.

As shown in FIG. 1, the encircling member 20 can further comprise a hinge assembly 100 for opening and closing the collar. The hinge assembly 100 can comprise a locking mechanism to hold the collar together when locked.

In other embodiments of the present invention, the connector member 30 can incorporate wheels and roll inside, outside, or within the encircling member 20. The connector member 30 can further include a handle for the hand or for fingers. The connector member 30 and/or the loop 32 can be personalized as well, incorporating favored animal shapes, team logos, astrology signs, flags, one's initials, and the like.

In preferred embodiments, the connector member 30 is movable 360 degrees about the entire neck such that the movement of the connector member 30. In other embodiments, the connector member 30 can have restricted movement about the neck, or slowed movement when traversing a hinge or other element of the present invention.

While the invention has been disclosed in its preferred forms, it will be apparent to those skilled in the art that many modifications, additions, and deletions can be made therein without departing from the spirit and scope of the invention and its equivalents, as set forth in the following claims.

1. A collar assembly comprising an encircling member for encircling a portion of an animal, and a connector member that can rotate about the animal in communication with the encircling member, wherein the connector member does not contact the animal.

2. The collar assembly of claim 1, wherein the encircling member comprises a body, a platform extending outward from the body, and a track system in which the connector member can move.

3. The collar assembly of claim 2, wherein the body and platform are releasably securable from one another.

4. The collar assembly of claim 2, wherein the track system comprises two opposing tracks at the junction of the body and the platform.

5. The collar assembly of claim 4, wherein the connector member comprises two flanges movable within the two tracks.

6. The collar assembly of claim 1, wherein the encircling member comprises a body and an inwardly formed channel in which the connector member can move.

7. The collar assembly of claim 6 further comprising jewelry located within the channel.

8. A collar assembly for the neck of an animal comprising an encircling member for encircling the neck, and a connector member in communication with the encircling member, and moveably about the encircling member 360 degrees around the neck, wherein the connector member does not contact the neck.

9. The collar assembly of claim 8, wherein the encircling member comprises a body that contacts at least portions of the neck, a platform extending outward from the body, and a track system in which the connector member can move, wherein the track system includes two opposing tracks at the junction of the body and the platform.

10. The collar assembly of claim 9, wherein the body and platform are releasably securable from one another.

11. The collar assembly of claim 8, wherein the encircling member comprises a body that contacts at least portions of the neck and an inwardly formed channel in which the connector member can move.

12. The collar assembly of claim 11 further comprising jewelry located within the channel.

13. The collar assembly of claim 8, wherein the encircling member comprises a gel layer in contact with the neck.

14. The collar assembly of claim 8, wherein the encircling member comprises a magnetic layer.

15. The collar assembly of claim 8, wherein the connector member is in the form of an animal.
